(19) United States
(12) Patent Application Publication
(10) Pub. No.: US 2016/0161756 A1
(43) Pub. Date: Jun. 9, 2016

(54) OPTICAL IMAGE STABILIZATION ACTUATOR MODULE

(71) Applicant: TOPRAY MEMS INC., Hsinchu City (TW)

(72) Inventors: Chin-Sung LIU, Hsinchu City (TW); Ping-Ju CHANG, Hsinchu City (TW)

(73) Assignee: TOPRAY MEMS INC., Hsinchu City (TW)

(21) Appl. No.: 14/954,847

(22) Filed: Nov. 30, 2015

(30) Foreign Application Priority Data
Dec. 8, 2014 (TW) 103221730

(51) Int. Cl. G02B 27/64

(52) U.S. Cl. CPC G02B 27/646

(57) ABSTRACT

An optical image stabilization actuator module includes a base, a ball holder, a plurality of balls, a plurality of coils, a plurality of yokes, and a plurality of magnets. The base is disposed with a plurality of ball support pillars; the ball holder is disposed with a plurality of ball housing spaces; the ball holder is disposed on top of the base. The balls are disposed between the ball support pillars and the ball housing spaces. The coils are fixed to the base, the yokes are fixed to the base, and the magnets are fixed to the surroundings of the ball holder. When a continuous current is applied to the coils, a magnetic force is generated by the coils. The interaction among the magnetic force, the yokes and the magnets enables the ball holder and the lens carrier to move in two degrees of freedom.

### CROSS-REFERENCE TO RELATED APPLICATION

The present application is based on, and claims priority form, Taiwan Patent Application No. 103221730, filed Dec. 8, 2014, the disclosure of which is hereby incorporated by reference herein in its entirety.

### TECHNICAL FIELD

The present disclosure generally relates to an optical actuator, and in particular, related to an optical actuation device for image stabilization.

### BACKGROUND

The portable devices, such as, smart phone or tablet PC, become ubiquitous, and are often used for photography or image recording. Shaky hands in using smart phone or tablet PC to take picture often results in blurred images. Therefore, the demand of a mechanic mechanism to provide an optical stabilization function is high.

FIG. 1 shows a schematic view of a structure of a conventional camera module. As shown in FIG. 1, the camera module 100 includes an image sensor module 110, an optical lens module 120 and an actuator module 130. The optical lens module 120 is disposed in a lens carrier 131 of the actuator module 130 so that the actuator module 130 actuates the lens carrier 131 to move the optical lens module 120 to achieve optical shockproof.

Accordingly, when the camera module 100 shakes due to external forces, the actuator module 130 pushes the lens carrier 131 to move towards the first lateral axis 140 and the second lateral axis 150 in a translational motion. The translational motion towards the first lateral axis 140 and the second lateral axis 150 can compensate the image error caused by external shake on the camera module 100 to obtain high quality image. The direction of the optical axis 160 is the light-entering direction of the optical lens module 120 inside the lens carrier 131. The first lateral axis 140 is defined as an axial direction perpendicular to the optical axis 160, and the second lateral axis 150 is defined as another axial direction perpendicular to the optical axis 160. In addition, the first lateral axis 140 and the second lateral axis 150 are perpendicular to each other.

### SUMMARY

The present disclosure provides an actuator with optical image stabilization function, applicable to optical image stabilization module based on lens shift method.

An embodiment of the present disclosure provides an optical image stabilization actuator module, enabling a lens carrier to move in two degrees of freedom. The optical image stabilization actuator module includes a base, a ball holder, a plurality of balls, a plurality of coils, a plurality of yokes, and a plurality of magnets. The base is disposed with a plurality of ball support pillars, and the ball holder is disposed with a plurality of ball housing spaces. The ball holder is disposed at the top of the base. Each of the plurality of balls is disposed between each of the plurality ball support pillars and each of the plurality of ball housing spaces. The plurality of coils is fixed to the base, the plurality of yokes is fixed to the base, and the plurality of the magnets is fixed to the surroundings of the ball holder. As such, when a continuous current is applied to the plurality of coils, a magnetic force is generated by the plurality of coils. The interaction among the magnetic force, the plurality of yokes and the plurality of magnets enables the ball holder to move in two degrees of freedom so that the lens carrier on the ball holder also moves in two degrees of freedom.

Another exemplary embodiment relates to an apparatus for adjusting-free automatic focus, the apparatus comprising: a lens, a lens holder seat, and a sensor integrated circuit, the lens is fixed to the lens holder seat with adhesion scheme, the sensor integrated circuit is set on focus plane of the lens.

### BRIEF DESCRIPTION OF THE DRAWINGS

FIG. 1 illustrates a schematic view of a conventional camera module.

FIG. 2A illustrates a schematic view of an optical image stabilization actuator module according to an exemplary embodiment.

FIG. 2B illustrates a schematic view of an assembled optical image stabilization actuator module according to an exemplary embodiment.

FIG. 2C illustrates a cross-sectional view of the ball housing space according to another exemplary embodiment.

FIG. 3A illustrates a schematic view of relative positions among the ball holder, balls and the base according to an exemplary embodiment.

FIG. 3B illustrates a schematic view of ball housing space housing the balls according to an exemplary embodiment.

FIG. 3C illustrates a schematic view of the assembly of ball holder and the lens carrier according to another exemplary embodiment.

FIG. 4A and FIG. 4B illustrate schematic views of the relative positions among the plurality of coils, the plurality of magnets and the plurality of yokes according to another exemplary embodiment.

FIG. 5A illustrates a schematic view of the magnetic force generated by the interaction of the magnets and the yokes according to another exemplary embodiment.

FIG. 5B and FIG. 5C illustrate schematic views of the interaction between the magnets and the yokes according to another exemplary embodiment.

FIG. 5D illustrates a schematic view of the effect on the ball holder by the effect of the magnet on the yoke according to another exemplary embodiment.

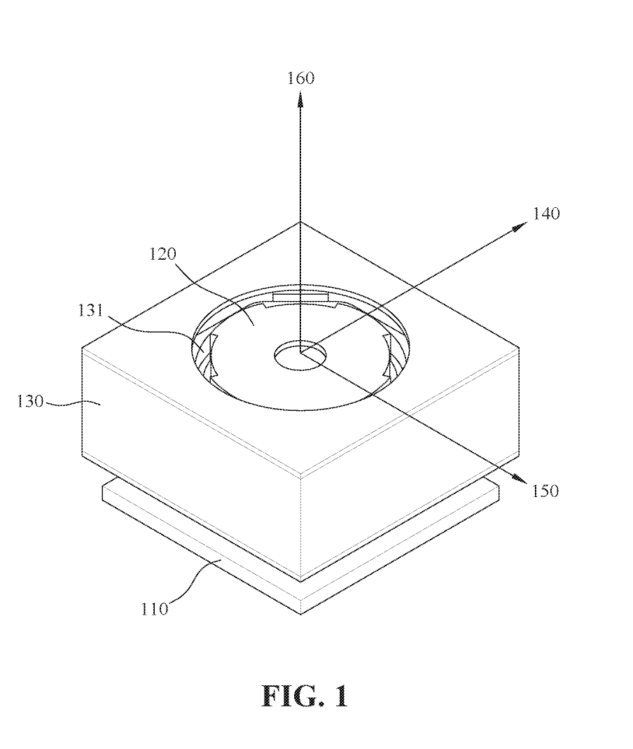

### DETAILED DESCRIPTION OF THE DISCLOSED EMBODIMENTS

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

The present disclosure provides an actuator with optical image stabilization function, applicable to optical image stabilization module based on lens shift method.

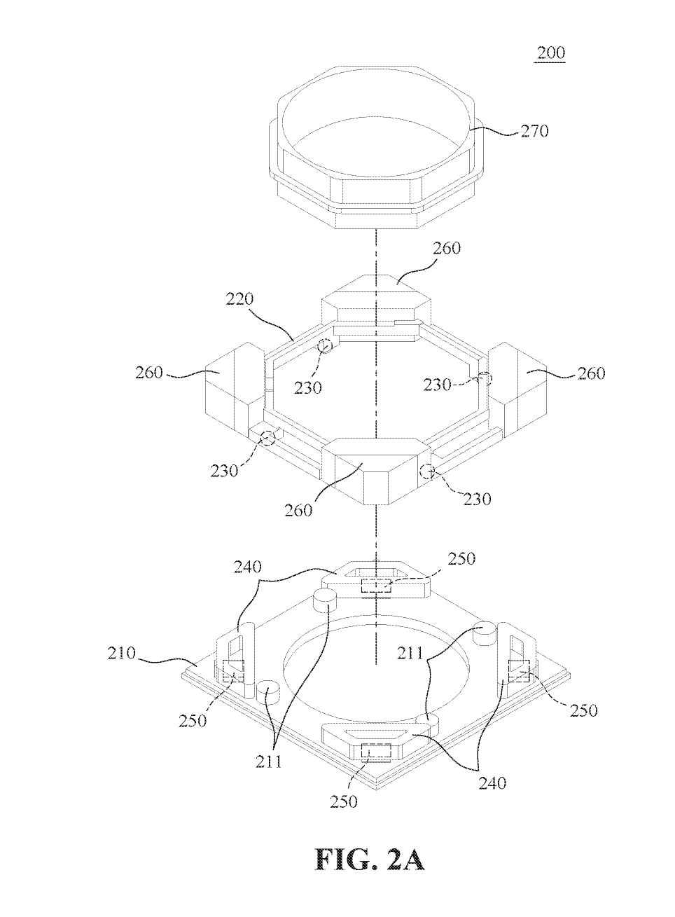

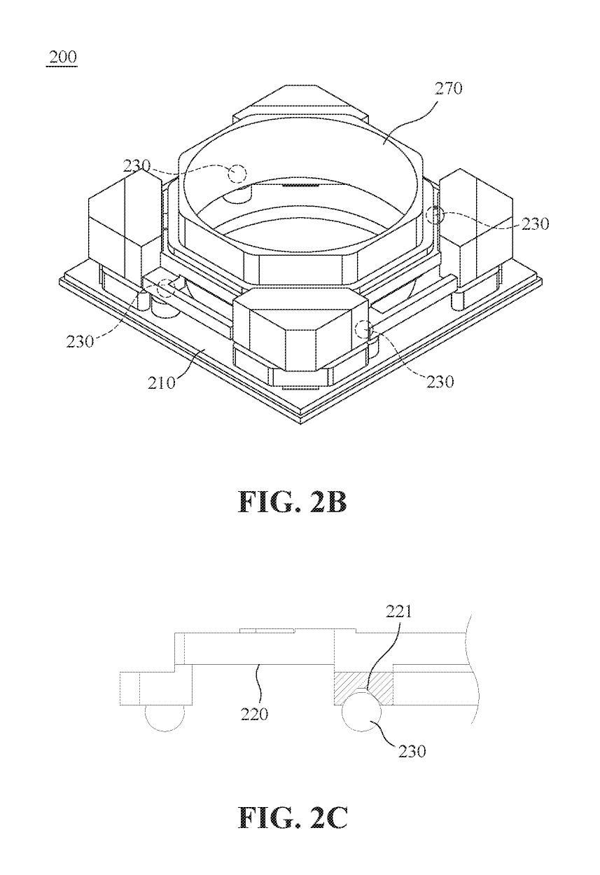

FIG. 2A illustrates a schematic view of an optical image stabilization actuator module according to an exemplary embodiment. As shown in FIG. 2A, the optical image stabilization module 200 enables a lens carrier 270 to move in two degrees of freedom. The optical image stabilization module 200 includes a base 210, a ball holder 220, a plurality of balls 230, a plurality of coils 240, a plurality of yokes 250, and a plurality of magnets 260. The base 210 is disposed with a plurality of ball support pillars 211, and the ball holder 220 is disposed with a plurality of ball housing spaces 221. The ball holder 220 is disposed at the top of the base 210. Each of the plurality of balls 230 is disposed between each of the plurality ball support pillars 211 and each of the plurality of ball housing spaces 221. The plurality of coils 240 is fixed to the base 210, the plurality of yokes 250 is fixed to the base 210, and the plurality of the magnets 260 is fixed to the surroundings of the ball holder 220. As such, when a continuous current is applied to the plurality of coils 240, a magnetic force is generated by the plurality of coils 240. The interaction among the magnetic force, the plurality of yokes 250 and the plurality of magnets 260 enables the ball holder 220 to move in two degrees of freedom so that the lens carrier 270 on the ball holder 220 also moves in two degrees of freedom.

Accordingly, the two degrees of freedom includes two directions for a lens in the lens carrier 270 to move. The two directions are parallel to the plane of the lens carrier 270, and the tow directions can be perpendicular to each other. The two directions are perpendicular to the optical axis of the lens. In other words, the plane defined by the two directions is perpendicular to the optical axis of the lens carrier.

The surrounding of the ball holder 220 is disposed with the plurality of magnets 260, and the ball housing spaces contacts the balls 230 without other physical entities for connection. The ball holder 220 uses a restoring force for motion restriction, i.e., the restoring force generated by the interaction of the plurality of magnets 260 and the plurality of yokes 250.

FIG. 2B illustrates a schematic view of an assembled optical image stabilization actuator module according to an exemplary embodiment. As shown in FIG. 2B, the plurality of balls 230 is located between the ball holder 220 carrying the lens carrier 270 and the base 210.

FIG. 2C illustrates a cross-sectional view of the ball housing space according to another exemplary embodiment. As shown in FIG. 2C, the ball housing space 221 can be a conic space.

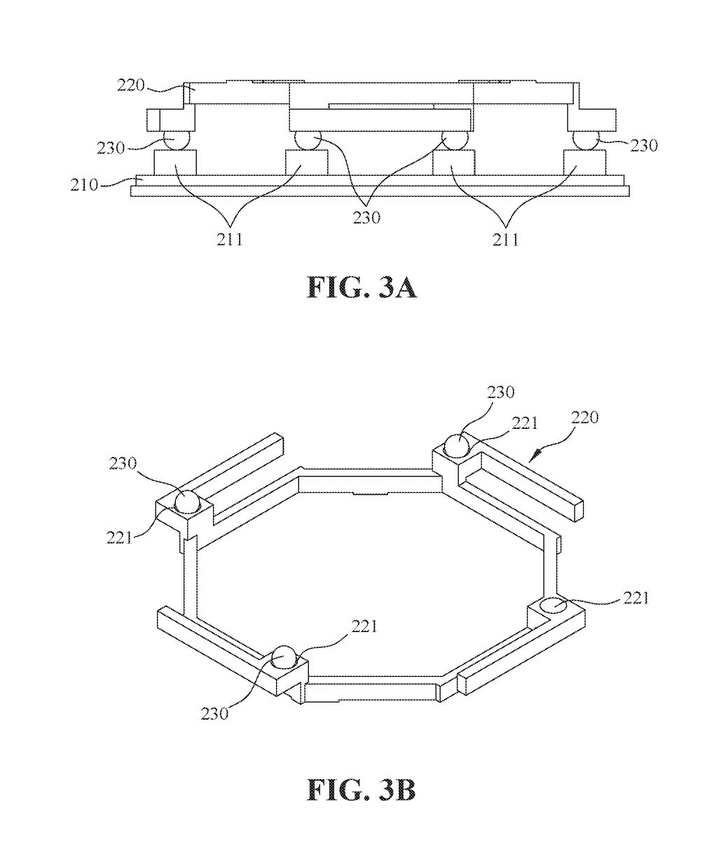

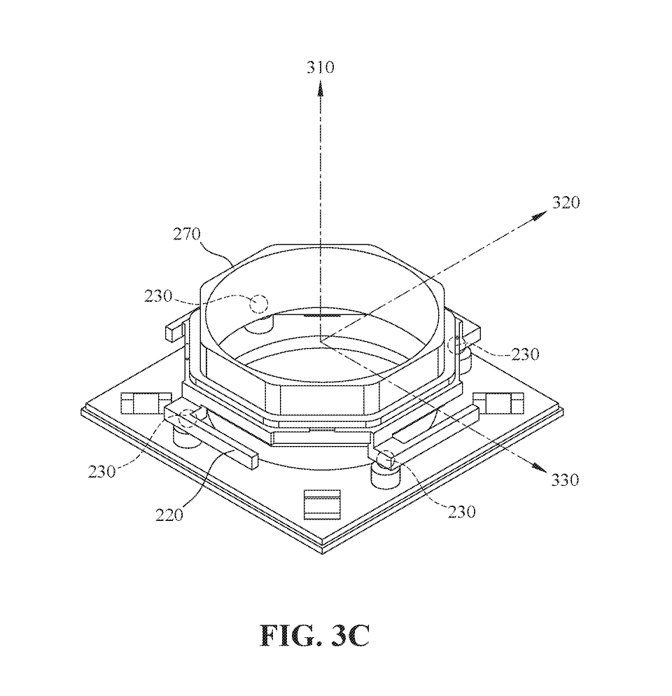

FIG. 3A illustrates a schematic view of relative positions among the ball holder, balls and the base, and FIG. 3B illustrates a schematic view of ball housing space housing the balls according to an exemplary embodiment. Refer to FIG. 3A and FIG. 3B simultaneously. In FIG. 3A, the ball holder 220 is disposed at the top of the base 210. The plurality of balls 230 is disposed between the ball holder 220 and the base 210. The plurality of balls 230 is located at the top of the ball support pillars 211, and the plurality of balls 230 is partially located inside the ball housing spaces 221 (not shown). The base 210 is a fixture (non-movable), and the ball holder 220 is supported by the plurality of balls 230 so that the ball holder 220 becomes a movable part. The ball housing spaces 221 (not shown) and the ball support pillars 211 are disposed correspondingly, and the surfaces of the ball support pillars 211 contacting the balls 230 are flat surfaces.

As shown in FIG. 3B, the ball holder 220 is flipped upside down in this view. The ball holder 220 is disposed with a plurality of ball housing spaces 221, with each of the ball housing spaces 221 to house a ball 230 respectively, wherein the ball housing spaces 221 is a non-spherical arc.

FIG. 3C illustrates a schematic view of the assembly of ball holder and the lens carrier according to another exemplary embodiment. As shown in FIG. 3C, the ball holder 220 and the lens carrier 270 can move in two degrees of freedom through the plurality of balls 230. With a vertical direction representing the light-entering direction of the optical axis 310 of the lens carrier 270, through the ball holder 220 and balls 230, when the lens carrier 270 moves towards the first lateral axis 230 or the second lateral axis 330 via an external force, the corresponding optical axis 310 of the lens carrier 270 will not tilt and maintain the lateral motion towards the first lateral axis 320 and the second lateral axis 330.

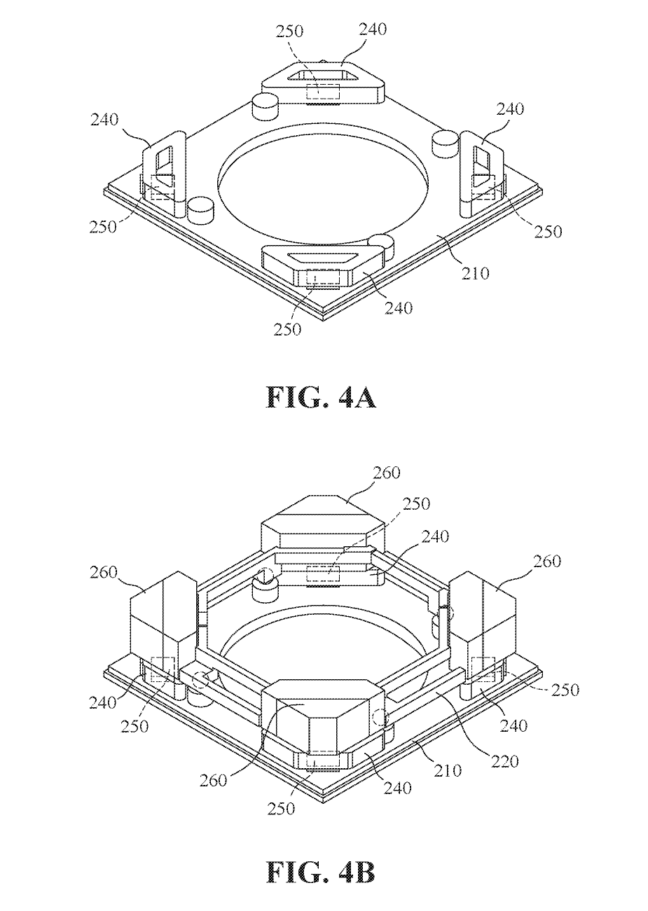

FIG. 4A and FIG. 4B illustrate schematic views of the relative positions among the plurality of coils, the plurality of magnets and the plurality of yokes according to another exemplary embodiment. As shown in FIG. 4A, the plurality of coils 240 and the plurality of yokes 250 are disposed at the corners of the base 210 respectively.

As shown in FIG. 4B, the plurality of coils 240 and the plurality of yokes 250 are fixed to the base 210, and the plurality of magnets 260 is attached to the ball holder 220. By applying a continuous current to the plurality of coils 240, and with the magnetic force generated through the magnets 260 and the coils 240, an external driving force can be generated according to the Lorentz force law. In addition, with the restoring force generated by the interaction between the magnets 260 and the yokes 250, when no external driving force is present, the restoring force enables the lens carrier 270 (not shown) to automatically restore to original position.

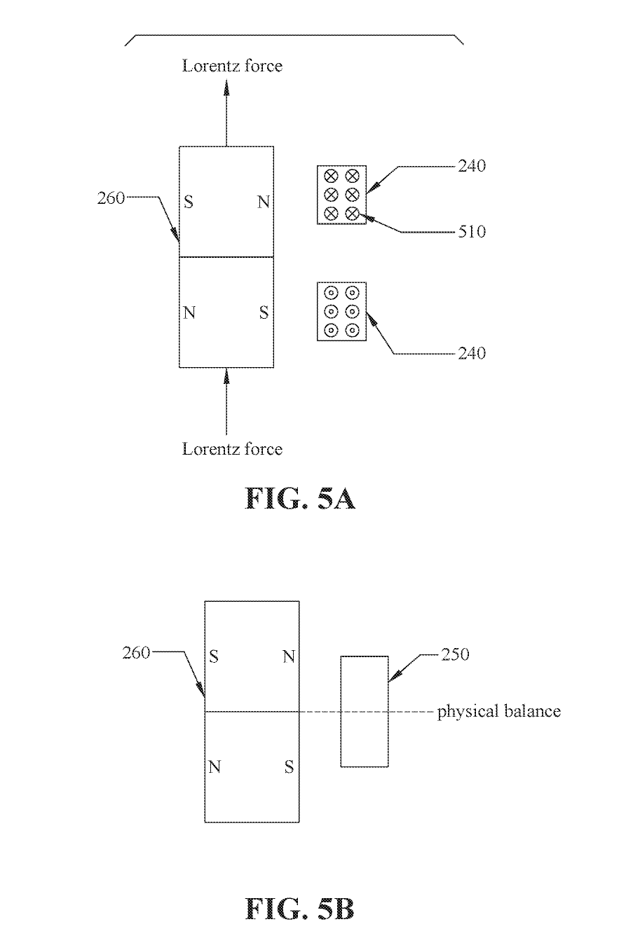

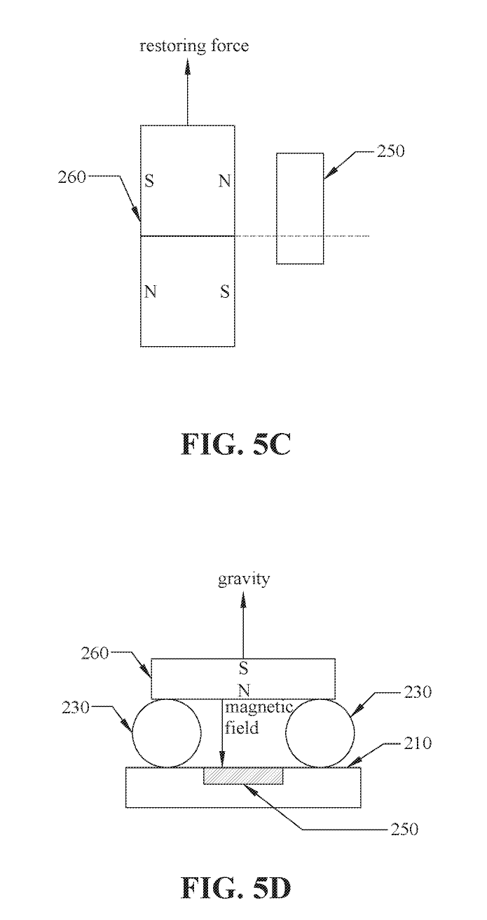

FIG. 5A illustrates a schematic view of the magnetic force generated by the interaction of the magnets and the yokes according to another exemplary embodiment. As shown in FIG. 5A, by applying a continuous current to the coils 240 the driving force generated by the direction 510 of the continuous current points to the first lateral axis and the second lateral axis so as to drive the lens carrier 270 to move laterally.

FIG. 5B and FIG. 5C illustrate schematic views of the interaction between the magnets and the yokes according to another exemplary embodiment. Refer to FIG. 5B and FIG. 5C simultaneously. As shown in FIG. 5B, the magnets 260 arranged correspondingly to N/S poles, the yokes 250 made of good magnetic conductivity material has a balance point with physics characteristics. As shown in FIG. 5C, when positions of the yokes 250 made of good magnetic conductivity material and the magnets 260 are off the balance point, a restoring force is generated to push the yokes 250 back to the balance point. Based on the theory of restoring force, when the coils 240 carries no current, i.e., the lens carrier (not shown) receives no external force, the lens carrier will automatically restore to original position regardless of the relative position of the lens carrier with respect to the base 210.

FIG. 5D illustrates a schematic view of the effect on the ball holder by the effect of the magnet on the yoke according to another exemplary embodiment. As shown in FIG. 5D, the attraction of the magnets 260 on the yokes 250 can provide a pre-pressure in the vertical direction and a restoring force in the horizontal direction to the balls 230 and the ball holder 220. In addition, for the camera module to be used in different positions, attraction of the magnets 260 on the yokes 250 can resist the gravity on the lens carrier to prevent the lens from disengaging from the ball holder. The yokes 250 can be of various shapes, such as, rectangular or I-shaped. As the shape of the yokes 250 will affect the magnetic field, different shapes of the yokes can be used for different magnetic field required.

In summary, the present disclosure provides an optical image stabilization actuator module. With the optical axis of the lens carrier not tilt, and when external driving force generated by the coils and the magnets is greater than the restoring force, the lens carrier can move laterally in two degrees of freedom to arrive designated position. On the other hand, when the current stops running through the coils, the restoring force of the yokes drives the lens carrier to restore to original position. As such, the object of preventing the lens carrier from optical shifting is accomplished.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An optical image stabilization actuator module, enabling a lens carrier to move in two degrees of freedom, comprising:
a base, disposed with a plurality of ball support pillars;
a ball holder, disposed with a plurality of ball housing spaces, and the ball holder being fixed to the top of the base;
a plurality of balls, disposed between the ball support pillars and ball housing spaces respectively;
a plurality of coils, fixed to the base;
a plurality of yokes, fixed to the base; and
a plurality of magnets, fixed to the surrounding of the ball holder;
wherein when a continuous current being applied to the plurality of coils, a magnetic force being generated by the plurality of coils; the interaction among the magnetic force, the plurality of yokes and the plurality of magnets enabling the ball holder to move in two degrees of freedom so that the lens carrier on the ball holder also moving in two degrees of freedom.

2. The optical image stabilization actuator module as claimed in claim 1, wherein the two degrees of freedom comprises two directions for a lens to move, and the two directions are perpendicular to the optical axis of the lens carrier.

3. The optical image stabilization actuator module as claimed in claim 1, wherein the ball housing spaces have a non-spherical arc shape to house the balls.

4. The optical image stabilization actuator module as claimed in claim 1, wherein the ball housing spaces are conic.

5. The optical image stabilization actuator module as claimed in claim 1, wherein the surfaces of the ball support pillars contacting the balls are flat surfaces.

6. The optical image stabilization actuator module as claimed in claim 1, wherein the ball support pillars and the ball housing spaces are disposed correspondingly to each other.

7. The optical image stabilization actuator module as claimed in claim 1, wherein with the optical axis of the lens carrier not tilt, and when external driving force generated by the coils and the magnets is greater than the restoring force of the yokes, the lens carrier can move laterally in two degrees of freedom to arrive designated position;
and, when the current stops running through the coils, the restoring force of the yokes drives the lens carrier to restore to original position to achieve the object of preventing the lens carrier from optical shifting.

8. The optical image stabilization actuator module as claimed in claim 1, wherein the magnetic effect of the magnets on the yokes can provide a pre-pressure in the vertical direction and a restoring force in the horizontal direction to the balls and the ball holder.

9. The optical image stabilization actuator module as claimed in claim 1, wherein the yokes are rectangular or I-shaped.

10. The optical image stabilization actuator module as claimed in claim 1, wherein the surrounding of the ball holder is disposed with the plurality of magnets, and the ball housing spaces contacts the balls without other physical entities for connection.
